(19) United States
(12) Patent Application Publication
(10) Pub. No.: US 2020/0363749 A1
(43) Pub. Date: Nov. 19, 2020

(54) IMAGING CORRECTION IN IMAGE FORMING APPARATUS

(71) Applicant: TOSHIBA TEC KABUSHIKI KAISHA, Tokyo (JP)

(72) Inventor: Masaki ICHIKAWA, Mishima Shizuoka (JP)

(21) Appl. No.: 16/986,788

(22) Filed: Aug. 6, 2020

Related U.S. Application Data
(63) Continuation of application No. 16/358,077, filed on Mar. 19, 2019.

(30) Foreign Application Priority Data
Jul. 10, 2018 (JP) 2018-130787

(51) Int. Cl. G03G 15/041; G03G 15/00

(52) U.S. Cl. CPC G03G 15/0415; G03G 15/5062

(57) ABSTRACT

An image forming apparatus includes an image forming unit configured to form an image on an image carrier using a developer, an image sensor configured to detect the image formed on the image carrier, and a correction controller configured to control the image forming unit to form an imaging correction pattern, and perform an imaging correction using a detection result of the image sensor detecting the image correction pattern. The correction controller is configured to control the image forming unit to form a first imaging correction pattern including a first number of one or more sub-patterns for an imaging correction until a predetermined condition is satisfied, and upon the predetermined condition being satisfied, form a second imaging correction pattern including a second number of sub-patterns more than the first number for a subsequent imaging correction.

### CROSS-REFERENCE TO RELATED APPLICATIONS

This application is a continuation of U.S. patent application Ser. No. 16/358,077, filed on Mar. 19, 2019, which is based upon and claims the benefit of priority from Japanese Patent Application No. 2018-130787, filed on Jul. 10, 2018, the entire contents of each of which are incorporated herein by reference.

### FIELD

Embodiments described herein relate generally to an image forming apparatus, in particular, imaging correction in the image forming apparatus.

### BACKGROUND

In an image forming apparatus, an image is formed on an image carrier, such as an intermediate transfer belt or the like, by using a developer, and the image is transferred onto a sheet. While forming the image on the image carrier, an imaging error may occur due to a problem with a laser unit or the like. If the image is formed without correcting the imaging error, inclination, distortion, and the like may be generated in an image formed on the sheet, and thus the image quality may deteriorate.

One of processes for correcting such an imaging error is correcting a main scanning partial magnification. For example, there is a technique of pre-storing data of a main scanning partial magnification in accordance with individual differences or assembling errors of lenses provided on an optical path of laser light irradiated to a photoconductor. In such a technique, the main scanning partial magnification is corrected using the stored data.

However, in the correction of main scanning partial magnification, there is a problem in that it is difficult to perform the correction with sufficient accuracy. Such a problem is commonly found in some imaging corrections including the correction of the main scanning partial magnification.

### DESCRIPTION OF THE DRAWINGS

FIG. 1 illustrates an external view of an image forming apparatus according to an exemplary embodiment.

FIG. 2 is a block diagram of a functional configuration related to imaging correction of the image forming apparatus according to the exemplary embodiment.

FIG. 3 is a diagram illustrating an example of an internal configuration of the image forming apparatus.

FIG. 4 is a diagram schematically illustrating a pattern detecting process carried out by a pattern detection sensor.

FIG. 5 is a diagram schematically illustrating skew correction.

FIG. 6 is a diagram schematically illustrating sub-scanning position correction.

FIG. 7 is a diagram schematically illustrating main scanning magnification correction.

FIG. 8 is a diagram schematically illustrating main scanning position correction.

FIG. 9 is a diagram schematically illustrating main scanning partial magnification correction.

FIG. 10 is a flowchart illustrating a specific example of a flow of imaging correction.

FIG. 11 is a flowchart illustrating a specific example of a flow of imaging correction.

### DETAILED DESCRIPTION

An exemplary embodiment provides an image forming apparatus capable of improving the accuracy of imaging correction.

In general, according to an embodiment, an image forming apparatus includes an image forming unit configured to form an image on an image carrier using a developer, an image sensor configured to detect the image formed on the image carrier, and a correction controller configured to control the image forming unit to form an imaging correction pattern, and perform an imaging correction using a detection result of the image sensor detecting the image correction pattern. The correction controller is configured to control the image forming unit to form a first imaging correction pattern including a first number of one or more sub-patterns for an imaging correction until a predetermined condition is satisfied, and upon the predetermined condition being satisfied, form a second imaging correction pattern including a second number of sub-patterns more than the first number for a subsequent imaging correction.

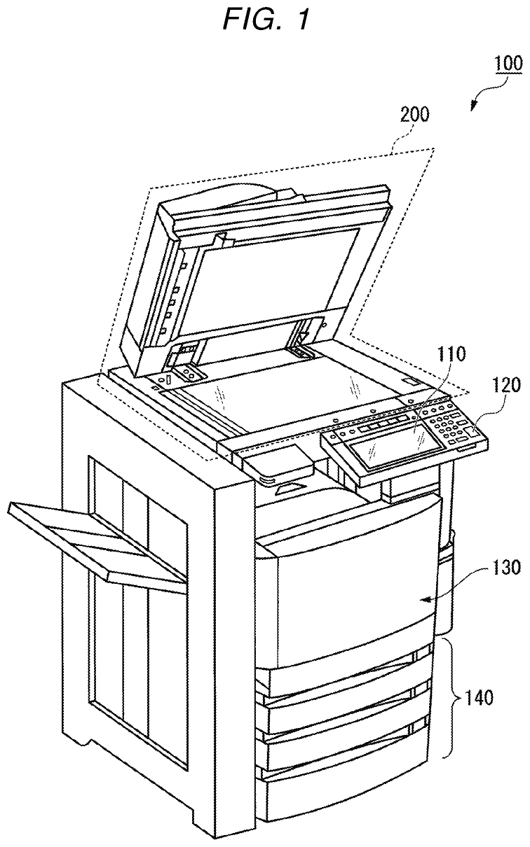

FIG. 1 illustrates an external view of an image forming apparatus 100 according to an exemplary embodiment. The image forming apparatus 100 is, for example, a multifunction printer. The image forming apparatus 100 includes a display 110, a control panel 120, a printer unit 130, a sheet accommodating unit 140, and an image reading unit 200. The image forming apparatus 100 forms an image on a sheet using a developer, such as toner or the like. The sheet is, for example, a piece of paper or a label. The sheet may be anything as long as the image forming apparatus 100 is capable of forming an image thereon.

The display 110 is an image display apparatus, such as a liquid crystal display (LCD), an organic electro-luminescence (EL) display, or the like. The display 110 displays various types of information related to the image forming apparatus 100.

The control panel 120 includes a plurality of buttons. The control panel 120 receives an operation from a user. The control panel 120 outputs a signal corresponding to an operation performed by the user to a control unit of the image forming apparatus 100. The display 110 and the control panel 120 may be configured as an integrated touch panel.

The printer unit 130 forms an image on the sheet based on image information generated by the image reading unit 200 or image information received via a communication path. The printer unit 130 includes an image forming unit 10, a fixer 30, an output unit 40, a transport unit, and the like, which will be described below. The printer unit 130 forms an image, for example, by using a developer, such as toner or the like. Also, the sheet on which the image is formed may be a sheet accommodated in the sheet accommodating unit 140 or a sheet manually inserted.

The sheet accommodating unit 140 accommodates a sheet used for the printer unit 130 to form an image thereon.

The image reading unit 200 reads image information to be received based on contrast of light. The image reading unit 200 records the read image information. The recorded image information may be transmitted to another information processing apparatus via a network. The recorded image information may be formed, as an image, on the sheet by the printer unit 130.

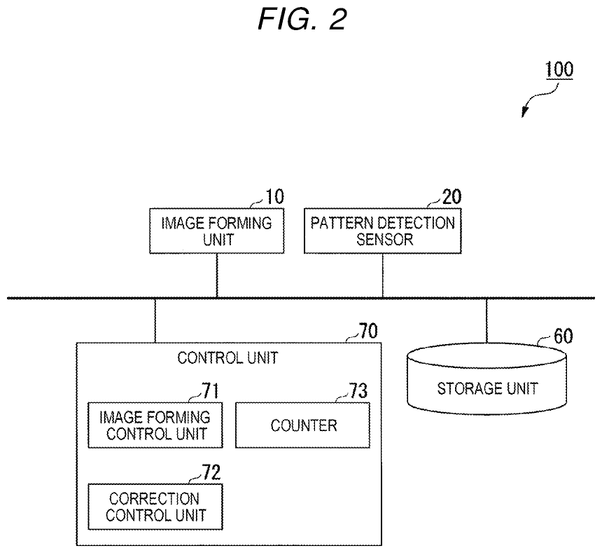

FIG. 2 is a block diagram of a functional configuration related to imaging correction of the image forming apparatus 100 according to the exemplary embodiment. The imaging correction is a process for correcting a position deviation of a visible image formed on the image carrier of the image forming unit 10. In the correction, for example, a certain shape (hereinafter, referred to as a “pattern”) is formed on an image carrier, and a size and direction of the position deviation are detected based on information, such as the length between the formed patterns, or the like. The image forming apparatus 100 includes the image forming unit 10, a pattern detection sensor 20, a storage unit 60, and a control unit 70.

The image forming unit 10 operates according to control of an image forming control unit 71 of the control unit 70. The image forming unit 10 includes developing units 12 to 16, a plurality of primary transfer rollers 17, a secondary transfer unit 18, an exposure unit 19, and the like, which will be described hereinafter. For example, the image forming unit 10 operates as follows. The exposure unit 19 of the image forming unit 10 forms an electrostatic latent image on a photoconductive drum according to image information of an image forming subject. The developing units 12 to 16 of the image forming unit 10 form a visible image by adhering a developer to the electrostatic latent image. The primary transfer rollers 17 of the image forming unit 10 transfer the formed visible image to the image carrier (an intermediate transfer body 11). The secondary transfer unit 18 of the image forming unit 10 transfers the visible image formed on the image carrier onto the sheet.

The pattern detection sensor 20 detects a pattern formed by the developer on the image carrier (the intermediate transfer body 11) of the image forming unit 10. The pattern detection sensor 20 may be configured, for example, using an optical sensor. A distance between patterns is calculated according to a time from when the pattern detection sensor 20 detects a certain pattern to when the pattern detection sensor 20 detects a next pattern, and a moving (rotating) speed of the image carrier during the time.

The storage unit 60 includes a storage device, such as a magnetic hard disk device, a semiconductor storage device, and the like. The storage unit 60 is used for a process of the control unit 70.

The control unit 70 is includes a processor, such as a CPU, and the like. The control unit 70 functions as an image forming control unit 71, a correction control unit 72, and a counter 73, as the processor executes a program.

The image forming control unit 71 controls the image forming unit 10 to form a visible image corresponding to an image designated for printing by the user, on a sheet.

The correction control unit 72 controls execution of imaging correction. For example, the correction control unit 72 executes a first imaging correction and a second imaging correction, which are pre-determined. The first imaging correction includes, for example, skew correction, sub-scanning position correction, main scanning magnification correction, and main scanning position correction. The second imaging correction includes, for example, main scanning partial magnification correction. The correction control unit 72 performs the second imaging correction when a certain time has elapsed since the performing of the previous second correction.

The correction control unit 72 controls formation of a pattern used for imaging correction. In detail, the correction control unit 72 forms a relatively small number (for example, 7 sets) of patterns from when a second imaging correction is performed to when a following second imaging correction is performed. On the other hand, the correction control unit 72 forms a relatively large number (for example, 14 sets) of patterns when a second imaging correction is performed. A plurality of the patterns described above are formed in a same main scanning direction. Further, the number of patterns indicates the number of sets of patterns formed in parallel in a sub-scanning direction. The correction control unit 72 determines when to perform a second imaging correction using the counter 73.

The counter 73 is controlled by the correction control unit 72. The counter 73 is reset when a second correction is performed. Then, the counter 73 increments a count number according to a certain time. Accordingly, a time elapsed since the performing of the previous second imaging correction may be obtained by referring to a value of the counter 73.

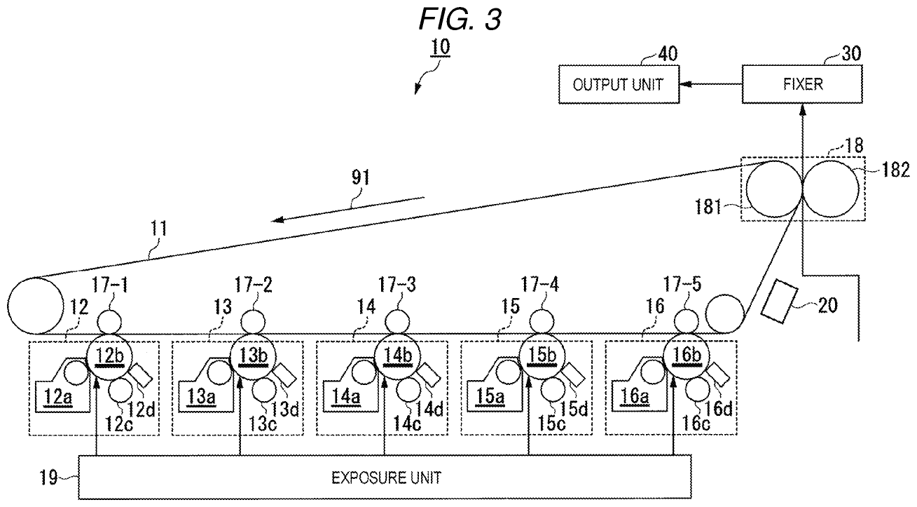

FIG. 3 is a diagram illustrating an example of an internal configuration of the image forming apparatus 100. In the example of FIG. 3, the image forming apparatus 100 is an image forming apparatus of five-tandem-type. However, the image forming apparatus 100 is not limited to the five-tandem-type.

The image forming apparatus 100 includes the image forming unit 10, the pattern detection sensor 20, the fixer 30, and the output unit 40. The image forming unit 10 includes the intermediate transfer body 11, the developing units 12 to 16, the plurality of primary transfer rollers 17 (17-1 to 17-5), the secondary transfer unit 18, and the exposure unit 19.

The intermediate transfer body 11 is a specific example of an image carrier. The intermediate transfer body may include, for example, an endless belt. The intermediate transfer body 11 is rotated in a direction indicated by an arrow 91 by a roller. In the embodiment, an upstream and a downstream are defined based on a direction in which the intermediate transfer body 11 moves. A visible image generated by the developing units 12 to 16 is transferred onto a surface of the intermediate transfer body 11. A pattern used for imaging correction is also formed on the surface of the intermediate transfer body 11. Transferring of the visible image onto the intermediate transfer body 11 corresponds to a primary transfer process.

The developing units 12 to 16 form a visible image using toner of different properties. For example, toner of different colors may be used in some developing units. As the toner of different colors, toner of yellow (Y), magenta (M), cyan (C), and black (K) may be used. For example, toner of which color disappears by an external stimulus (for example, heat) may be used in some developing units. The developing unit 12 is positioned most upstream among five developing units and the developing unit 16 is positioned most downstream among five developing units.

The developing units 12 to 16 have a same configuration, despite of the difference in properties of toner being used. Hereinafter, a developing unit will be described using the developing unit 12 as an example.

The developing unit 12 includes a developer container 12a, a photoconductive drum 12b, a charger 12c, and a cleaning blade 12d.

The developer container 12a accommodates a developer. In the developer container 12a, the developer adheres to the photoconductive drum 12b.

The photoconductive drum 12b includes a photoconductor (photoconductive area) on an outer peripheral surface. The photoconductor is, for example, an organic photoconductor (OPC).

The charger 12c uniformly charges the surface of the photoconductive drum 12b.

The cleaning blade 12d is, for example, a plate-like member. The cleaning blade 12d is formed of, for example, rubber, such as urethane resin, or the like. The cleaning blade 12d removes the developer adhered to the photoconductive drum 12b.

Operations of such a developing unit 12 will be briefly described. The photoconductive drum 12b is charged to a certain potential by the charger 12c. Then, light is irradiated from the exposure unit 19 onto the photoconductive drum 12b. Accordingly, the potential of a region of the photoconductive drum 12b, where the light is irradiated, is changed. According to such a change, an electrostatic latent image is formed on the surface of the photoconductive drum 12b. The electrostatic latent image on the surface of the photoconductive drum 12b is developed by the developer in the developer container 12a. In other words, a visible image that is an image developed by the developer is formed on the surface of the photoconductive drum 12b.

The primary transfer rollers 17 (17-1 to 17-5) transfer the visible image formed on photoconductive drums 12b to 16b by the developing units 12 to 16, respectively, to the intermediate transfer body 11.

The secondary transfer unit 18 includes a secondary transfer roller 181 and a secondary transfer counter roller 182. The secondary transfer unit 18 collectively transfers the visible image formed on the intermediate transfer body to a sheet subjected to image formation. The transferring by the second transfer unit 18 is performed base on a potential difference between, for example, the secondary transfer roller 181 and the secondary transfer counter roller 182.

The exposure unit 19 forms an electrostatic latent image by irradiating light onto the photoconductive drums 12b to 16b of the developing units 12 to 16. The exposure unit 19 includes a light source, such as a laser source, a light-emitting diode (LED), or the like.

The pattern detection sensor 20 is provided to detect a pattern of the intermediate transfer body 11 between the secondary transfer unit 18 and the developing unit 16 at the most downstream.

The fixer 30 heats and pressurizes the visible image transferred onto the sheet to fix the visible image on the sheet.

The output unit 40 discharges the sheet on which the visible image is fixed by the fixer 30.

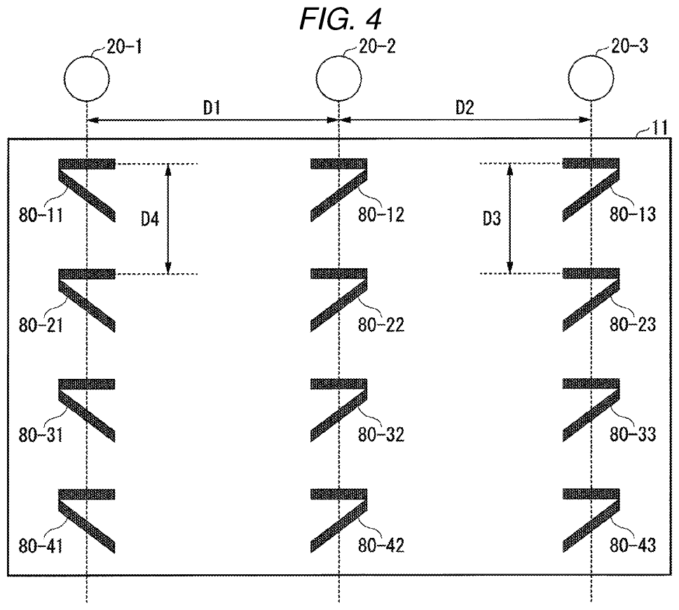

FIG. 4 is a diagram schematically illustrating a pattern detecting process carried out by the pattern detection sensor 20. A plurality of the pattern detection sensors 20 are provided in parallel to each other in a main scanning direction. In an example of FIG. 4, three pattern detection sensors 20 are provided in parallel to each other in the main scanning direction. For convenience, a pattern detection sensor 20-1 is referred to as a “rear sensor 20-1”, a pattern detection sensor 20-2 is referred to as a “center sensor 20-2”, and a pattern detection sensor 20-3 is referred to as a “front sensor 20-3”. Here, the front and rear respectively denote a front side and a rear side of the image forming apparatus 100. A side where the control panel 120 is provided is the front side, and the opposite side (generally, a side facing a wall surface or the like) is the rear side. The center sensor 20-2 is provided between the rear sensor 20-1 and the front sensor 20-3.

In FIG. 4, D1 indicates a distance between the center of a detection region of the rear sensor 20-1 and the center of a detection region of the center sensor 20-2 in the main scanning direction. D2 indicates a distance between the detection region of the center sensor 20-2 and a detection region of the front sensor 20-3 in the main scanning direction. D1 and D2 may be the same distance or different distances.

A pattern is formed in a detection region of each pattern detection sensor 20. For example, patterns 80-11, 80-12, and 80-13 are formed in parallel to each other on a same main scanning line. The pattern 80-11 is formed such that a center portion thereof is substantially located at the center of the detection region of the rear sensor 20-1. The pattern 80-12 is formed such that a center portion thereof is substantially located at the center of the detection region of the center sensor 20-2. The pattern 80-13 is formed such that a center portion thereof is substantially located at the center of the detection region of the front sensor 20-3.

A plurality of patterns are formed in a sub-scanning direction, as one set. For example, patterns using different types of developers may be formed in the sub-scanning direction. For example, the patterns 80-11, 80-12, and 80-13 are formed using cyan toner; patterns 80-21, 80-22, and 80-23 are formed using magenta toner; patterns 80-31, 80-32, and 80-33 are formed using yellow toner; and patterns 80-41, 80-42, and 80-43 are formed using black toner. Such a plurality of patterns are formed as one set of patterns.

Correction is performed according to the width and distance of each pattern included in one set. For example, an inclination between formation of a visible image of a type of toner used for the patterns 80-11 through 80-13 and formation of a visible image of a type of toner used for the patterns 80-21 through 80-23 may be calculated according to values of D3 and D4 illustrated in FIG. 4. A parameter for correcting the inclination may be calculated based on the calculated value. The correction is performed in this manner.

Hereinafter, skew correction, sub-scanning position correction, main scanning magnification correction, main scanning position correction, and main scanning partial magnification correction are described as specific examples of the imaging correction.

Skew Correction

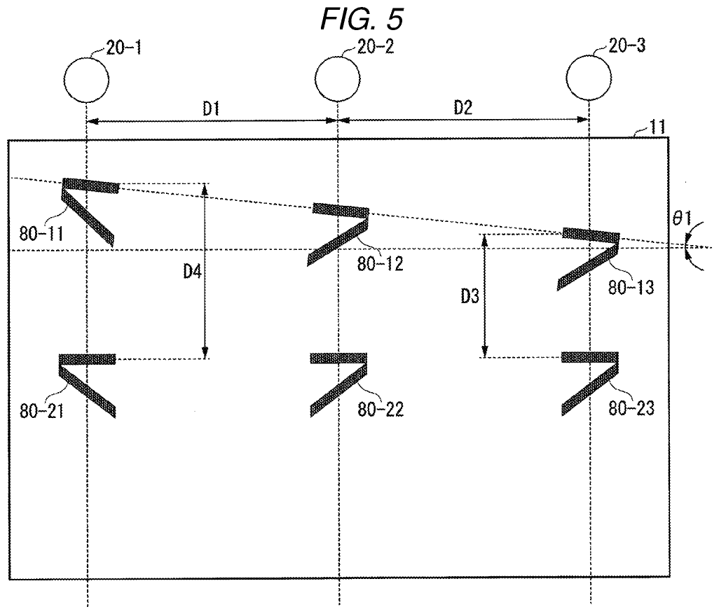

FIG. 5 is a diagram schematically illustrating skew correction. In FIG. 5, the cyan patterns 80-11 through 80-13 are inclined by an angle 01 with respect to the magenta patterns 80-21 through 80-23. For example, when the magenta patterns 80-21 through 80-23 are defined as reference patterns, in skew correction, a deviation of the angle θ1 is corrected by changing the inclination of a mirror. By such correction, an inclination of a position of a cyan visible image and a position of a magenta visible image become parallel.

A specific example of the skew correction is as follows. First, a distance D4 between the pattern 80-11 and the pattern 80-21 and a distance D3 between the pattern 80-13 and the pattern 80-23 are calculated. For example, a position of the mirror used for formation of the cyan visible image is corrected such that a difference between D3 and D4 becomes zero. For example, an inclination of an image used for formation of a visible image is corrected such that the difference between D3 and D4 becomes zero.

Position Correction in Sub-Scanning Direction

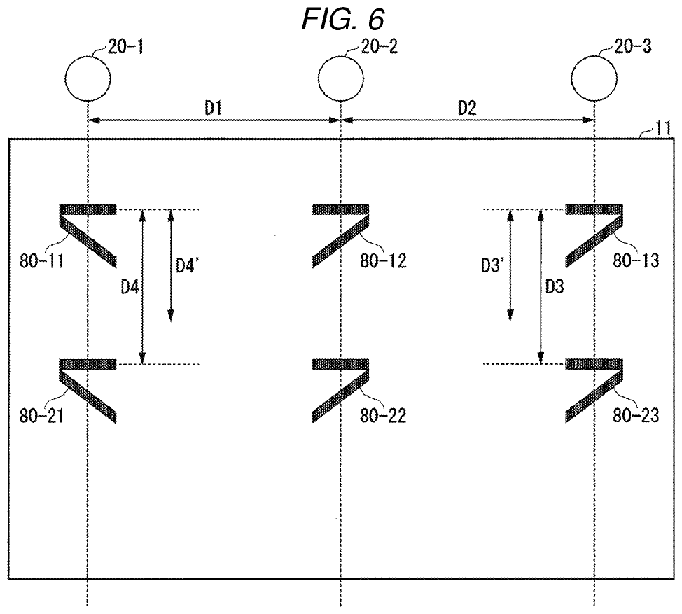

FIG. 6 is a diagram schematically illustrating position correction in a sub-scanning direction. In FIG. 6, the cyan patterns 80-11 through 80-13 are separated from the magenta patterns 80-21 through 80-23 by D3 (=D4) in the sub-scanning direction. For example, when the magenta patterns 80-21 through 80-23 are defined as reference patterns, a reference value D3′ (=D4′) is pre-defined with respect to a distance between each cyan pattern and each magenta pattern in the sub-scanning direction. In sub-scanning position correction, the distance D3 in the sub-scanning direction is corrected to match the reference value D3′. By such sub-scanning position correction, a distance between the position of the cyan visible image and the position of the magenta visible image match a reference value.

A specific example of the sub-scanning position correction is as follows. First, the distance D3 between the pattern 80-13 and the pattern 80-23 is calculated. For example, a start timing of formation of the cyan visible image in the sub-scanning direction is corrected such that a difference between the distance D3 and the reference value D3′ becomes zero.

Magnification Correction in Main Scanning Direction

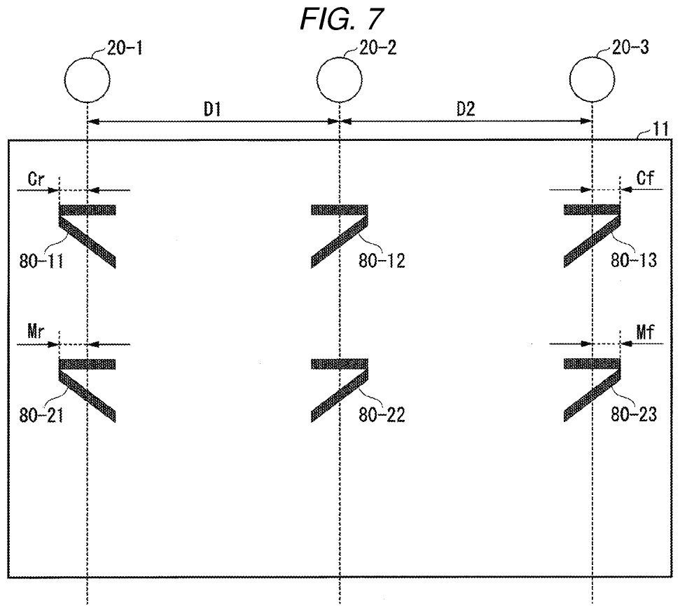

FIG. 7 is a diagram schematically illustrating magnification correction in a main scanning direction. In FIG. 7, magnification of the cyan patterns 80-11 through 80-13 in the main scanning direction is corrected to match magnification of the magenta patterns 80-21 through 80-23 in the main scanning direction. In particular, the magnification in the main scanning direction is corrected such that a difference between a value of Cr+Cf and a value of Mr+Mf becomes zero. The correction of the magnification in the main scanning direction is performed by, for example, changing a frequency of an image clock per pixel of an image subject to image formation.

The number of waves of the image clock per pixel is a fixed value. Accordingly, the length of a visible image per pixel in the main scanning direction is changed by changing the frequency of the image clock. For example, when the frequency of the image clock is increased, the length of the visible image per pixel in the main scanning direction is decreased. For example, when the frequency of the image clock is decreased, the length of the visible image per pixel in the main scanning direction is increased. By such main scanning magnification correction, the length of the cyan visible image in the main scanning direction and the length of the magenta visible image in the main scanning direction are matched.

Position Correction in Main Scanning Direction

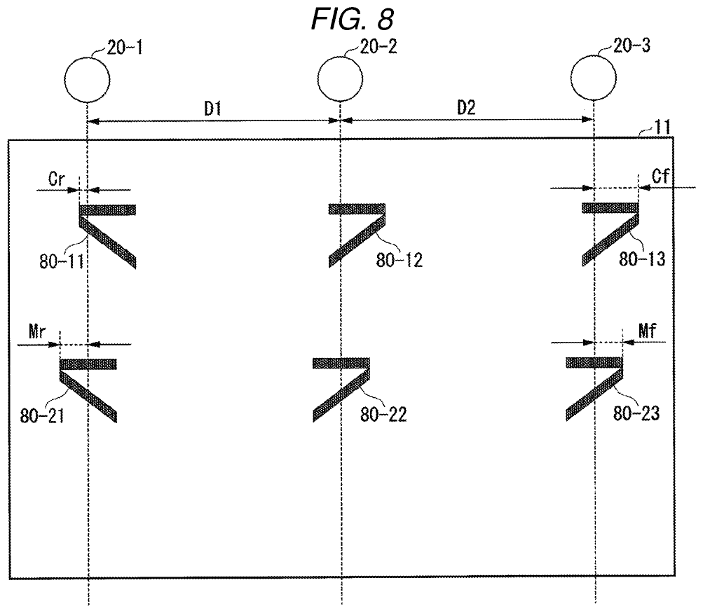

FIG. 8 is a diagram schematically illustrating main scanning position correction. In FIG. 8, starting positions of the cyan patterns 80-11 through 80-13 with respect to starting positions of the magenta patterns 80-21 through 80-23 are misaligned in the main scanning direction. For example, when the magenta patterns 80-21 through 80-23 are defined as reference patterns, the misalignment between a starting position of a cyan pattern and a starting position of a magenta pattern is corrected to be zero. By such main scanning position correction, the starting position (beginning position) of the cyan visible image and the starting position (beginning position) of the magenta visible image are matched.

A specific example of the main scanning position correction is as follows. First, a value Cr of the pattern 80-13 and a value Mr of the pattern 80-21 are calculated. For example, a start timing of formation of the cyan visible image in the main scanning direction is corrected such that a difference between the value Cr and the value Mr becomes zero.

Partial Magnification Correction in Main Scanning Direction

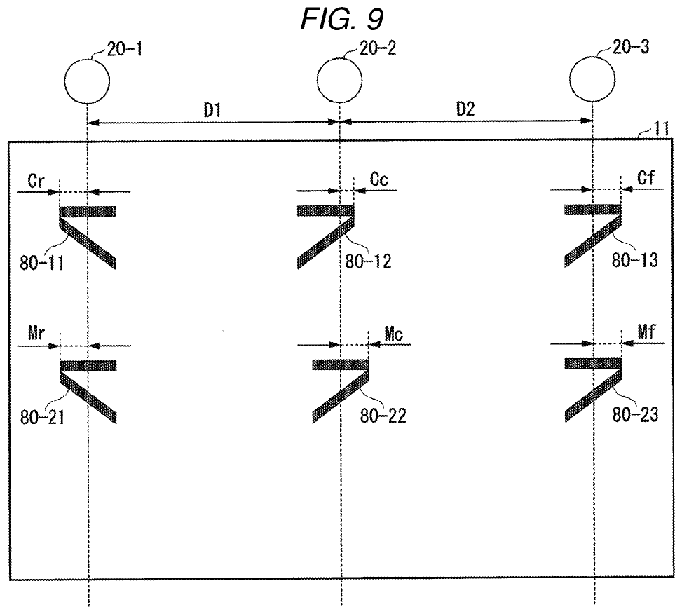

FIG. 9 is a diagram schematically illustrating partial magnification correction in the main scanning direction. In FIG. 9, the position of the cyan patter 80-12 and the position of the magenta pattern 80-22 are misaligned in the main scanning direction. For example, when the magenta patterns 80-21 through 80-23 are defined as reference patterns, a difference between magnification of a region of the distance D1 of a cyan pattern in the main scanning direction and magnification of a region of the distance D1 of a magenta pattern in the main scanning direction is corrected to become zero. Similarly, a difference between magnification of a region of the distance D2 of a cyan pattern in the main scanning direction and magnification of a region of the distance D2 of a magenta pattern in the main scanning direction is corrected to become zero. By such main scanning partial magnification correction, magnification of a visible image of an inner region (the regions of the distances D1 and D2) of a cyan visible image in the main scanning direction and magnification of a visible image of an inner region (the regions of the distances D1 and D2) of a magenta visible image in the main scanning direction are matched.

A specific example of the main scanning partial magnification correction is as follows. First, a value Cc of the pattern 80-12 and a value Mc of the pattern 80-22 are calculated. For example, a frequency of an image clock per pixel of an image subject to image formation is changed such that a difference between the value Cc and the value Mc becomes zero.

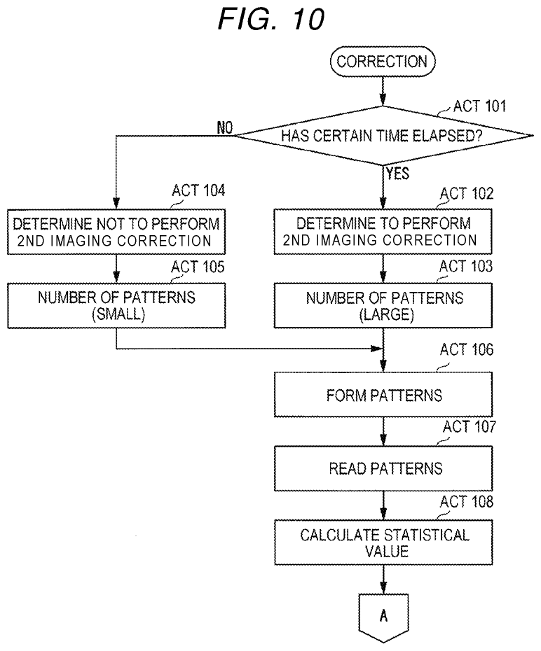

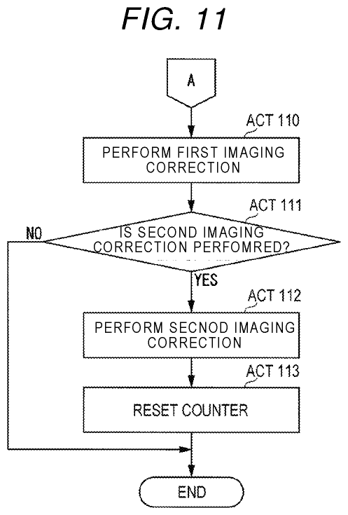

FIGS. 10 and 11 are flowcharts illustrating a specific example of a flow of imaging correction. The imaging correction is repeatedly performed at certain timing. When the imaging correction starts, the correction control unit 72 determines whether a certain time has elapsed since a previous second imaging correction by referring to a counter value (ACT 101). When the certain time has elapsed since the performing of the previous second imaging correction (Yes in ACT 101), the correction control unit 72 determines to perform a second imaging correction (ACT 102). Then, the correction control unit 72 determines the number of sets of patterns to be formed to be a relatively large number (ACT 103).

On the other hand, when the certain time has not elapsed since the previous second correction (No in ACT 101), the correction control unit 72 determines not to perform a second imaging correction (ACT 104). Then, the correction control unit 72 determines the number of sets of patterns to be formed to be a relatively small number (ACT 105).

Next, the correction control unit 72 instructs the image forming control unit 71 to form the determined number of sets of patterns. The image forming control unit 71 controls the image forming unit 10 to form the determined number of sets of patterns on an image carrier (ACT 106). The pattern detection sensor 20 detects each pattern formed on the image carrier. Based on a detection result of the pattern detection sensor 20, the correction control unit 72 obtains a value indicating a position of each pattern (ACT 107). The correction control unit 72 calculates a statistical value between sets with respect to values indicating positions of patterns obtained in each set (ACT 108). For example, an average value may be calculated with respect to the values of the positions of each set.

Then, the correction control unit 72 performs a first imaging correction according to the statistical value of the values indicating the positions of patterns calculated in ACT 108 (ACT 110). When it is determined to perform the second imaging correction (Yes in ACT 111), the correction control unit 72 performs the second imaging correction according to the statistical value of the values indicating the positions of patterns calculated in ACT 108 (ACT 112). Then, the correction control unit 72 resets a value of the counter 73 (ACT 113). Then, the correction control unit 72 ends the imaging correction.

When it is determined not to perform the second imaging correction (No in ACT 111), the correction control unit 72 ends the imaging correction.

In the image forming apparatus 100 configured as such, a relatively large number of sets of patterns are formed when a second imaging correction is performed after a certain time has elapsed. Then, positions of the relatively large number of sets of patterns are detected, and the imaging correction is performed based on a statistical value thereof. In this manner, positions of patterns may be obtained based on statistical values of more patterns, and thus effects of disturbances, such as meandering of the image carrier (for example, a belt of the intermediate transfer body 11), eccentricity of a photoconductive drum, and the like may be reduced, and the correction may be performed more accurately.

When the relatively large number of sets of patterns are constantly formed, too much time may be consumed for the imaging correction and at the same time, a large amount of developer may be used. In this regard, in the current embodiment, a relatively small number of sets of patterns are formed until a certain time is elapsed since the performing of the imaging correction in which the relatively large number of sets of patterns are formed. Accordingly, it is possible to maintain a balance between the accuracy of imaging correction and costs (the time and the amount of a developer) required for the imaging correction. In particular, when correction having more influence on the image quality, such as main scanning partial magnification correction, is performed as a second imaging correction, the accuracy may be improved by using the relatively large number of sets of patterns.

### Modification Example

The correction control unit 72 may perform imaging correction in which a relatively large number of sets of patterns are formed based on a condition that a certain temperature change has occurred in or around an image forming apparatus instead of a condition that a certain time has elapsed. In particular, the correction control unit 72 forms a relatively small number of patterns (for example, 7 sets) until a certain temperature change occurs to a temperature measured when a previous second imaging correction was performed. The correction control unit 72 forms a relatively large number of patterns (for example, 14 sets) when the certain temperature change occurs to the temperature measured when the previous second imaging correction was performed. A position deviation of a visible image formed on an image carrier of the image forming unit 10 may be generated due to a deformation of a member caused by a temperature change. Thus, according to the configuration above, imaging correction may be performed at an appropriate timing. Also, the second imaging correction may be performed when a temperature difference is large within a day, for example, at 2:00 and 14:00.

While certain embodiments have been described, these embodiments have been presented only as an example, and are not intended to limit the scope of the inventions. Indeed, the embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
an image forming unit configured to form an image on an image carrier using a developer;
an image sensor configured to detect the image formed on the image carrier; and
a correction controller configured to control the image forming unit to form an imaging correction pattern, and perform an imaging correction using a detection result of the image sensor detecting the image correction pattern, wherein
the correction controller is configured to:
control the image forming unit to form a first imaging correction pattern including a first number of sets for an imaging correction until a predetermined condition is satisfied, the first number being one or more, and
upon the predetermined condition being satisfied, control the image forming unit to form a second imaging correction pattern including a second number of sets more than the first number for a subsequent imaging correction, the second number of sets being arranged in a sub-scanning direction, wherein each set of the first image correction pattern consists of a third number of sub-patterns, each of which has a predetermined shape, the third number being two or more, and
each set of the second image correction pattern consists of the third number of sub-patterns, each of which has the predetermined shape.

2. The image forming apparatus according to claim 1, wherein
the third number of sub-patterns included in each set of the first image correction pattern have different colors, respectively, and
the third number of sub-patterns included in each set of the second image correction pattern have the different colors, respectively.

3. The image forming apparatus according to claim 1, wherein the image forming unit consists of a plurality of sub image forming units configured to form images of the different colors on the image carrier, respectively.

4. The image forming apparatus according to claim 1, wherein the predetermined condition is satisfied when a time period that have passed since a previous image correction using an image correction pattern including the second number of the sets reached a threshold.

5. The image forming apparatus according to claim 1, wherein the predetermined condition is satisfied when a difference of a temperature around the image forming apparatus from a temperature around the image forming apparatus during a previous image correction using an image correction pattern including the second number of the sets reached a threshold.

6. The image forming apparatus according to claim 1, wherein
the imaging correction using the first imaging correction pattern includes a first type of imaging correction, and does not include a second type of image correction different from the first type, and
the subsequent imaging correction using the second imaging correction pattern incudes the second type of imaging correction.

7. The image forming apparatus according to claim 6, wherein the second type of imaging correction includes a partial magnification correction in a main scanning direction.

8. The image forming apparatus according to claim 6, wherein the first type of imaging correction includes at least one of a skew correction, a position correction in a sub-scanning direction, a position correction in a main scanning direction, and a magnification correction in the main scanning direction.

9. The image forming apparatus according to claim 6, wherein the subsequent imaging correction using the second imaging correction pattern incudes also the first type of imaging correction.

10. The image forming apparatus according to claim 1, wherein the first number is two or more, and the first number of the sets of the first imaging correction pattern are arranged in the sub-scanning direction.

11. A method for performing an imaging correction in an image forming apparatus including an image forming unit configured to form an image on an image carrier using a developer, the method comprising:
until a predetermined condition is satisfied,
forming, on the image carrier, a first imaging correction pattern including a first number of sets, the first number being one or more;
detecting the first imaging correction pattern using an image sensor; and
performing an imaging correction using a detection result of the image sensor detecting the first imaging correction pattern; and
upon the predetermined condition being satisfied,
forming a second imaging correction pattern including a second number of sets more than the first number, the second number of sets being arranged in a sub-scanning direction;
detecting the second imaging correction pattern using the image sensor; and
performing an imaging correction using a detection result of the image sensor detecting the second imaging correction pattern, wherein
each set of the first image correction pattern consists of a third number of sub-patterns, each of which has a predetermined shape, the third number being two or more, and
each set of the second image correction pattern consists of the third number of sub-patterns, each of which has the predetermined shape.

12. The method according to claim 11, wherein
the third number of sub-patterns included in each set of the first image correction pattern have different colors, respectively, and
the third number of sub-patterns included in each set of the second image correction pattern have the different colors, respectively.

13. The method according to claim 12, wherein the image forming unit consists of a plurality of sub image forming units configured to form images of the different colors on the image carrier, respectively.

14. The method according to claim 11, wherein the predetermined condition is satisfied when a time period that have passed since a previous image correction using an image correction pattern including the second number of the sets reached a threshold.

15. The method according to claim 11, wherein the predetermined condition is satisfied when a difference of a temperature around the image forming apparatus from a temperature around the image forming apparatus during a previous image correction using an image correction pattern including the second number of the sets reached a threshold.

16. The method according to claim 11, wherein
the imaging correction using the first imaging correction pattern includes a first type of imaging correction, and does not include a second type of image correction different from the first type, and
the subsequent imaging correction using the second imaging correction pattern incudes the second type of imaging correction.

17. The method according to claim 16, wherein the second type of imaging correction includes a partial magnification correction in a main scanning direction.

18. The method according to claim 16, wherein the first type of imaging correction includes at least one of a skew correction, a position correction in a sub-scanning direction, a position correction in a main scanning direction, and a magnification correction in the main scanning direction.

19. The method according to claim 16, wherein the subsequent imaging correction using the second imaging correction pattern incudes also the first type of imaging correction.

20. The method according to claim 11, wherein the first number is two or more, and the first number of the sets of the first imaging correction pattern are arranged in the sub-scanning direction.
